(19) United States
(12) Patent Application Publication
(10) Pub. No.: US 2004/0143733 A1
(43) Pub. Date: Jul. 22, 2004

(54) Secure network data storage mediator

(75) Inventors: Sefy Ophir, Raanana (IL); Elic Yavor, Barkan (IL)

Correspondence Address: OLIFF & BERRIDGE, PLC, P.O. BOX 19928, ALEXANDRIA, VA, 22320, US

(73) Assignee: CLOVERLEAF COMMUNICATION CO., Geneva (CH)

(21) Appl. No.: 10/345,348

(22) Filed: Jan. 16, 2003

(51) Int. Cl. H04L 9/00

(52) U.S. Cl. 713/153

(57) ABSTRACT

A mediator for the protection of data in storage devices over a network. The mediator connects over the network to one or more data clients and to one or more data storage devices, and provides secure storage of data for the data clients on the data storage devices. The mediator functions as a central point for the encryption of data from the data clients to be stored on the storage devices, as well as decryption of the encrypted data retrieved from the storage devices for delivery to the data clients. The mediator can handle multiple protocols, such as IP protocols, file service protocols, and block device protocols; multiple storage technologies such as Fiber Channel and Ethernet; and multiple services such as block, file, and database services. The mediator can also perform various fictions such as protocol translation. The mediator benefits from the fact that all storage devices, as well as data clients, are connected over a network, thereby allowing flexibility, expandability, and scalability of configurations without the limitations imposed by local interconnectivity. At the same time, however, the mediator provides secure virtual storage to data clients without requiting them to be involved in any of the encryption or decryption operations. In particular, data clients are not burdened with compulsory management of any keys used in the protection of stored data. As a result, the encryption/decryption of stored data can be optimized for security without concerns for key distribution.

### FIELD OF THE INVENTION

The present invention relates to the secure storage of data over a network, and, more particularly, to a network mediating device for administering the security of data stored in devices connected over a network.

### BACKGROUND OF THE INVENTION

Providing security for data stored in a device is generally accomplished by encrypting the data prior to storing in the device and decrypting the data after retrieval from the device, so that data in storage in the device is unusable by anyone who does not possess the appropriate decryption algorithm or key. There are many different schemes and variations on this general theme, however, depending on the specific security needs and the characteristics of the applicable environment.

For example, FIG. 1 is a generalized block diagram showing the configuration of a secure data storage system 101 as widely found in the prior art Secure data storage system 101 includes a Central Processing Unit (CPU) 103, a storage device 105 with peripheral controller 107, and a cryptographic unit 109. In the prior art, these components are typically connected to one another via bus or their equivalents, such as by a bus 111 connecting CPU 103 to peripheral controller 107 and to cryptographic unit 109. A system with such a configuration is disclosed in U.S. Pat. No. 5,748,744 to Levy, et al. (herein denoted as “Levy”). In Levy, the goal is to secure data on mass storage devices which might be accessible to many users of such a system. Thus, Levy is suited for application to mass-storage associated with a mainframe computer that serves a number of separate users. Nevertheless, it is noted that the basic configuration disclosed by Levy and utilized in similar prior-art systems is applicable to any computer system having components interconnected by a bus, as illustrated in FIG. 1, including smaller systems such as personal computers.

Another prior-art configuration for secure data storage is illustrated in FIG. 2, which shows a “data vault” 201, containing a server (or functionally equivalent unit) 203, a storage device 205, and a cryptographic unit 207 (which may be part of server 203). Data vault 201 is usually employed in the context of a network 209 and connected to a number of data clients, such as a data client 211, a data client 213, and a data client 215, who communicate with data vault 201 via a virtual circuit 217, a virtual circuit 219, and a virtual circuit 221, respectively. It is noted that in this prior-art configuration, data vault 201 may be connected to a network, but does not utilize the network for internal operation. For example, server 203 is connected to storage device 205 via a bus (or functionally equivalent means) 223. That is, the server, storage and encryption means are local to one another, even though the information itself may be stored and retrieved on behalf of remote clients. Systems with such a configuration are disclosed in U.S. Pat. No. 6,105,131 to Carroll (herein denoted as “Carroll”); in U.S. Pat. No. 6,202,159 to Ghafir, et al. (herein denoted as “Ghafir”); and in U.S. Pat. No. 6,356,941 to Cohen (herein denoted as “Cohen”). The term “data client” herein denotes any client wishes to place data in storage or retrieve data from storage.

A further prior-art configuration for secure data storage involving distributed data storage devices, and the most widely-encountered configuration, is illustrated in FIG. 3. Multiple storage devices, such as a storage device 301, a storage device 303, and a storage device 305, arm connected to a network 307. Also connected to network 307 are multiple data clients, such as a data client 309 and a data client 313. These data clients have available cryptographic capabilities, such as by a cryptographic unit 311 connected to data client 309 and a cryptographic unit 317 connected to data client 313. Units such as these are locally connected to their respective clients, such as illustrated for data client 309, which is connected to cryptographic unit 311 by a local bus 315. Although the data storage is handled via network 307, the protection of the data involves cryptographic operations which must be performed locally by the data clients, and thus the data clients are involved in important and critical technical details of the data protection. Systems having features of such a configuration are disclosed in U.S. Pat. No. 5,719,938 to Haas, et al. (herein denoted as “Hans”), and in U.S. Pat. No. 6,098,056 to Rusnak et al. (herein denoted as “Rusnak”).

A still filter example of the prior art is disclosed in U.S. Pat. No. 5,931,947 to Bums et al. herein denoted as “Burns”), which teaches a network storage device, wherein the data clients are wholly responsible for encrypting the data.

The prior art solutions discussed above have certain limitations which detract from their data storage abilities, particularly in today's wide-area network environments. Some of the prior art secure data storage systems provide storage capabilities that offer the network advantages of flexibility, expandability, and scalability, but which require data clients to perform procedures related to critical cryptographic operations necessary for data security. This puts stringent limitations on the ability of the system to optimize encryption methods and keys. To gain optimal security for data all clients must use the same cryptographic and key management methods, and changes in the cryptography must be shared with all the data clients. These requirements can impose heavy burdens on the system and may be impracticable for remote heterogeneous clients. Systems such as those proposed by Burns, Haas, and Rusnak have this limitation. Other prior art secure data storage systems handle both storage and encryption (thereby alleviating the encryption burden on the data clients), but are limited to configurations where data storage and encryption must be local relative to one another. This restricts the system from being able to take full advantage of the flexibility, expandability, and scalability of the network, and can limit the growth of the data-handling capacity of the system. Systems such as those proposed by Levy, Carroll, Ghafir, and Cohen have this limitation.

There is thus a need for, and it would be highly advantageous to have, a network system for secure data storage which offers both the flexibility, expandability, and scalability of the network, but which also places no encryption burdens on the data clients. This goal is met by the present invention.

### SUMMARY OF THE INVENTION

It is an objective of the present invention to provide secure data storage accessible to data clients over a network without requiring the data clients to perform any operations related to the security of the stored data, including, but not limited to encryption, decryption, key management, key distribution, key storage, and key updating. It is noted that, although the present invention imposes no requirement for data clients to perform security-related operations, according to embodiments of the present invention, data clients can optionally perform encryption and decryption. The performing of security operations by data clients is not compulsory in embodiments of the present invention.

It is also an objective of the present invention to perform all encryption functions over the network (i.e., where all connections are though networks to clients and storage devices), in order to take advantage of the flexibility, expandability, and scalability of the network, and to avoid the limitations of local connections between encryption units and storage devices.

The present invention is of a secure data storage mediator. A non-limiting configuration featuring such a device is illustrated in FIG. 4. A mediator 401 is connected to a network 403 over which operation is conducted. A data client 405 and a data client 407 communicate with mediator 401 via network connections, such as a virtual circuit 409. Likewise, mediator 401 communicates via network connections with a data storage device 411, a data storage device 413, and a data storage device 415. It is noted that, for clarity of illustration, FIG. 4 shows the use of the same network for both data client and data storage device connections, but a set of networks can also be used, such as an incoming network to support data sent from data clients, a storage network to support data sent to data storage devices, a retrieval network to support data retrieved from data storage devices, and an outgoing network to support data sent to data clients. It is understood that these networks are not necessarily physically distinct, but rather have distinct functions and may be logically distinct. Two or more of these logically-distinct networks may in fact be the same network. Also, in this context, a set of networks includes at least one network, and may include one or more different network interface technologies, including, but not limited to: Ethernet, ATM, SONET, Fiber Channel, and SCSI.

Furthermore, it is noted that data sent to the mediator for storage by a particular data client can be retrieved by the mediator from storage and sent back to that same data client. Alternatively, the data can be retrieved by the mediator from storage and sent to a different data client. For example, data client 405 could be a sending data client that sends data to mediator 401, and mediator 401 could store the data in storage device 411. Later, mediator 401 can retrieve the data from storage device 411 and send the data back to data client 405. Alternatively, mediator 401 could, after retrieval from storage device 411, send the data to data client 407, which would be a receiving data client, instead of sending the data to sending data client 405. Normally, this alternative routing of retrieved data would require proper authorization. It is emphasized however, that the present invention provides for such a routing.

The mediator is able to receive data from, and transmit data to, any data client having access to the network. Likewise, the mediator is able to store data in, and retrieve data from, any suitable storage device having access to the network. In is manner, the mediator functions as a central coordinator for data storage between one or more clients requesting data storage and one or more storage devices providing data storage. In this central point, the mediator serves as a virtual secure storage device. The data clients do not have to be involved in any storage or retrieval operation with any storage devices, and need not know the locations where the data is stored. Similarly, the mediator performs encryption and decryption functions to secure the stored data without requiring the data clients to participate in any encryption or decryption on operations related to the security of stored data. (As noted previously, however, participation of the data clients in such encryption and decryption operations is not compulsory, but data clients may optionally perform encryption and/or decryption.) The data clients, for example, do not need to have access to any keys required for the encryption or decryption of stored data. In particular, the mediator is not ruined to obtain keys from the data clients, and in an embodiment of the present invention, the mediator obtains keys from sources other than a data client.

Note that the data clients may encrypt data for transmission to the mediator, and that the mediator may encrypt data for transmission to the data clients. Such encryption, and the corresponding decryption, is done for purposes of protecting the data in transit over the network between the data client and the mediator, and is distinct in several aspects from the encryption/decryption that is done to protect data while in storage. Data in transit may be en d according to client's requests, capabilities and using keys known to both client and mediator while data in storage is encrypted according to mediator's administrator request, mediator built-in capabilities and keys known only to the mediator.

The protection of data in transit has different goals and characteristics from those of the protection of data in storage. For example, protecting data in transit is usually done on a session basis using transient keys that do not survive the session, whereas protecting data in storage is normally done on a long-term basis with keys that are persistent over a relatively long period of time. In a system according to the present invention, whereas data clients may be involved m the encryption/deception of data in transit between them and the mediator, the data clients do not have to be involved in any aspects of the encryption/decryption of data in storage. The present invention contemplates that data clients may wish to protect data in transit them and the mediator, but techniques of such protection are well-known in the art and are not discussed herein The novel aspects of the present invention lie in the protection of data for storage, which the mediator performs over the network without imposing any compulsory involvement of the data clients (although, as noted previously, data clients may optionally perform security-related operations).

Therefore, according to the present invention there is provided a mediator for the storage and protection of data over a network, the mediator including: (a) an incoming network interface operative to connecting to a sending data client over an incoming network, and operative-to-receiving data from the sending data client; (b) an encryption unit for encrypting the data received from the sending data client; (c) a storage network interface operative to connecting to a data storage device over a storage network, for storing data in the data storage device after encryption by the encryption unit; (d) a retrieval network interface operative to connecting to the data storage device over a retrieval network, for retrieving data from the data storage device; (e) a decryption unit for decrypting the data retrieved from the data storage device; and (f) an outgoing network interface operative to connecting to a receiving data client over an outgoing network, and operative to sending data to the receiving data client after decryption by the decryption unit.

Furthermore, according to the present invention there is also provided a configuration for secure data storage, the configuration including: (a) a set of networks containing at least one network, (b) a sending data client connected to an incoming network included in the set of networks; (c) a receiving data client connected to an outgoing network included in the set of networks (d) a storage network included in the set of networks and connecting to a data storage device; (e) a retrieval network included in the set of networks and connecting to the data storage device; and (f) a mediator connected to the incoming network, to the storage network, to the retrieval network, and to the outgoing network, wherein the mediator is operative to: (i) receiving, over the incoming network, data from the sending data client; (ii) obtaining an encryption key from a source other than the sending data client; (iii) encrypting the data received from the sending data client into encrypted data, using the encryption key; (iv) sending, over the storage network, the encrypted data to the data storage device for storage therein; (v) receiving, over the retrieval network, encrypted data retrieved from the data storage device; (vi) obtaining a decryption key from a source other the receiving data client; (vii) decrypting the encrypted data retrieved from the data storage device into decrypted data, using the decryption key; and (viii) sending, over the outgoing network, the decrypted data to the receiving data client.

### BRIEF DESCRIPTION OF THE DRAWINGS

The invention is herein described, by way of example only, with reference to the accompanying drawings, wherein:

FIG. 1 is a generalized block diagram of a common prior-art secure data storage system configuration.

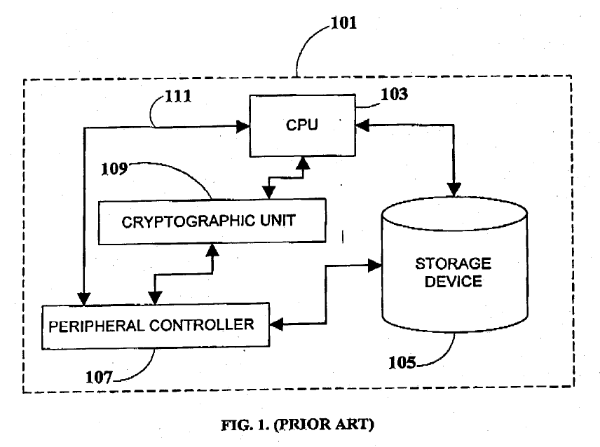

FIG. 2 is a conceptual diagram of a prior art secure data storage featuring a “data vault”.

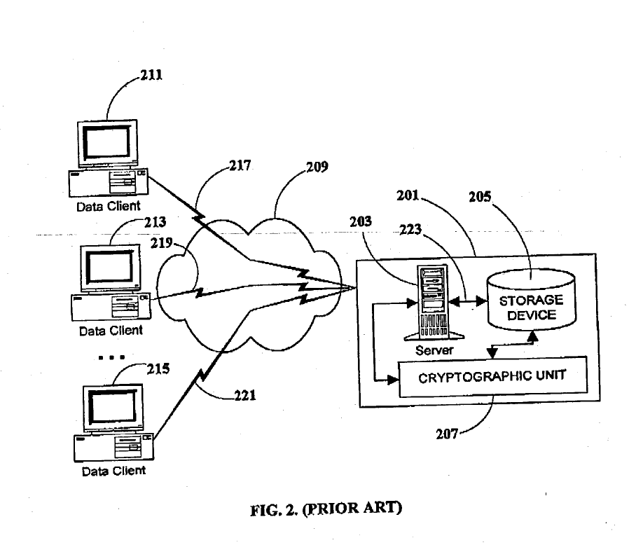

FIG. 3 conceptually illustrates a prior-art secure distributed data configuration.

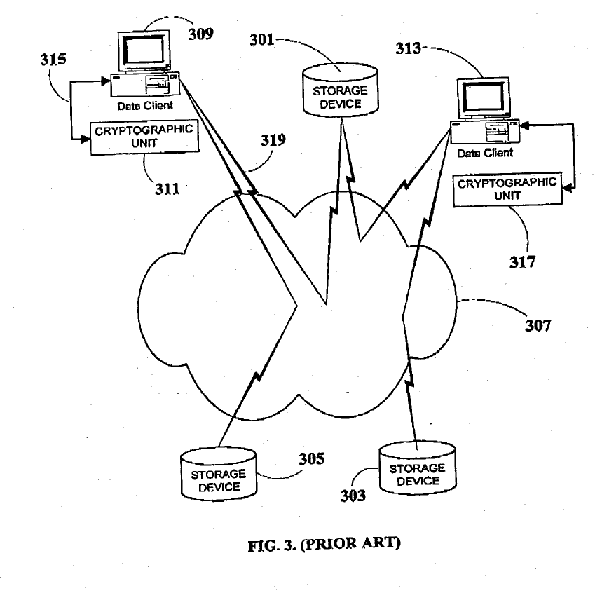

FIG. 4 conceptually illustrates a secure distributed data configuration featuring a mediator according to an embodiment of the present invention.

FIG. 5 is a block diagram of a mediator according to an embodiment the present invention.

FIG. 6 conceptually illustrates the versatility of secure virtue storage via a mediator of an embodiment of the present invention.

FIG. 7 illustrates some representative and non-limiting client services and protocols, networks, and storage device technologies supported by a configuration according to the present invention.

### DESCRIPTION OF THE PREFERRED EMBODIMENTS

The principles and operation of a secure data storage mediator according to the present invention may be understood with reference to the drawings and that accompanying description.

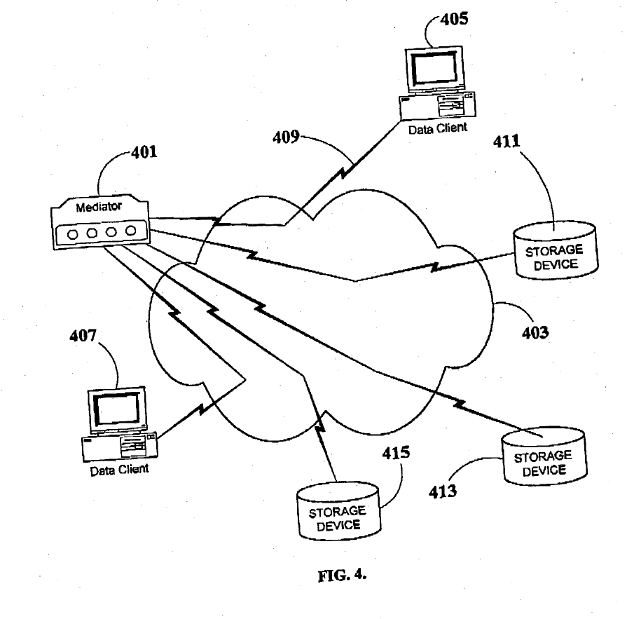

The environmental configuration of a secure da storage mediator is conceptually illustrated in FIG. 4, as previously discussed. Some of the features which distinguish the mediator of the present invention from devices and configurations of the prior art (as also previously discussed) center on the fact that the mediator operates as a central point for handling secure storage over a network both from the standpoint of the data clients as well as from the standpoint of the data storage devices, while not requiring the data clients to be involved with the protection of the data while in storage (but not prohibiting the data clients from such involvement, either). This is in contrast with the prior art, which either requires the data clients to encrypt and/or decrypt stored data (Burns, Haas, and Rusnak, for example), and/or depends on local, non-networked connections between the encryption/decryption unit and the storage devices (Carroll, Cohen, and Ghafir, for example).

In the case of the prior-art requirement for data clients to participate in the encryption and/or decryption processes, the lack of such a requirement by the present invention is a clear-cut advantage. In the case of the use of network connections between the mediator and data storage devices versus a dependence on local connections, however, it is helpful to clarify the distinctions between the network environment and connections, and the local environment and connections, along with the respective advantages thereof.

At the physical level, local connections (exemplified by bus connections) impose tightly-coupled relationships between devices, featuring direct access by one device to the resources of other devices. Contention between devices for the local connection is usually arbitrated at the physical level, with some tee of service. The resulting local connection is typically capable of high data transit rates, but is limited in scope regarding the number, physical placement, and interoperability of th devices that can be connected. Generally, a limited number of master devices (such as CPU's) can be present over a local bus, and data processing activity is highly centralized. In contrast, network connections are characterized by loose coupling through a higher-level protocol. A device on the network has no direct access to the resources of other devices, but may share resources through message-based requests that do not guarantee service. The resulting network connection generally has significantly lower data transfer rates than a local connection, but is highly flexible regarding the number, physical placement, and interoperability of the devices that can be connected. In particular, a suitable network can be expanded effectively without limit over a global geographical area, and highly sophisticated device interrelationships are possible over a network. An unlimited number of master devices can be present on a network, and data processing activity is highly distributed.

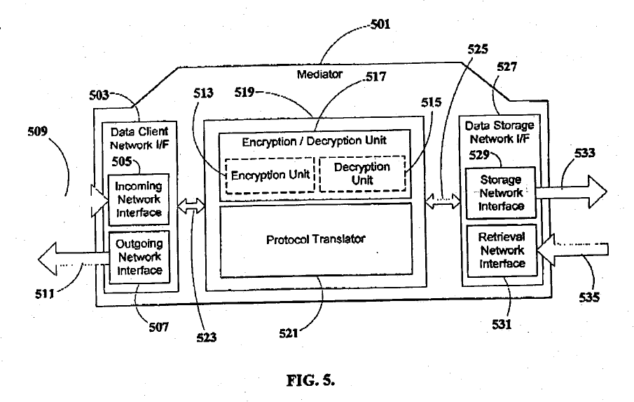

Accordingly, the interface (both the software interface as well as the hardware interface) which a device has to a network is qualitatively different from an interface the device would have to a local connection (such as a bus), and an important and novel feature of the present invention is the inclusion of suitable network interfaces. FIG. 5 illustrates the components of a mediator 501 of an embodiment of the present invention. In accordance with the above remarks regarding network versus local connections, mediator 501 has a data client network interface 503 that has a logical incoming network interface 505 supporting an incoming network connection 509 from a data client, and a logical outgoing network interface 507 supporting an outgoing network connection 511 to a data client Mediator 501 also has a data storage device network interface 527 that has a logical storage network intern 529 supporting a network connection 533 to a data storage device, and a logical retrieval network interface 531 supporting a network connection 535 from a data storage device. Within mediator 501 there is a data storage processor 519 containing an encryption/decryption unit 517 and a protocol translator 521. All data flows through mediator 501, which is an “in-band” device having a data channel 523 between data client network interface 503 and data storage processor 519, and a data channel 525 between data storage processor 519 and data storage device network interface 527. It is noted that incoming data client network interface 505, outgoing network interface 507, storage network interface 529, and retrieval network interface 531 need not all be physically distinct, but may be embodied physically in a smaller number of interfaces, wherein the various interfaces are logically distinguished from one another by predetermined parameters, including, but not limited to addressing and protocol selection. For example, it is understood that data client network interface 503 is at least logically distinct from data storage device network interface 527. As previously noted, the incoming network, storage network, retrieval network, and outgoing network need not be physically-distinct networks. All of them, in fact, can be the same physical network.

Protocol translation is provided because the data clients may employ a variety of client protocols, just at the storage devices may employ a variety of device protocols. The mediator according to the present invention is thus capable of translating between different client protocols and different device protocols.

Encryption/decryption unit 517 encrypts data from the data clients into encrypted data for safe storage in data storage devices, and decrypts data retrieved from data storage devices into decrypted data for sending to data clients. It is noted that in an alternative embodiment, encryption/decryption unit 517 includes two physically and/or logically separate functionalities: a distinct encryption unit 513 and a distinct decryption is unit 515. Encryption unit 513 encrypts data from data clients prior to storage in the data storage devices, and decryption unit 515 decrypts data retrieved from the data storage devices prior to sending the data to the data clients. Moreover, as noted previously, in one embodiment data client network interface 503 connects to the same network connected to data storage device network interface 527, but in another embodiment connects to a different network from that connected to data storage device network interface 527. In yet another embodiment, the network interface to the data clients and/or to the storage devices includes several different network interfaces (including, but not limited to, Fiber Channel and GbEthernet). Protocol translator 521 permits mediator 501 to bridge between different network protocols, non-limiting examples of which are: between Fiber Channel and Ethernet; between NFS and SCSI; and between SCSI and iSCSI. In any case, encryption/decryption unit 517 obtains and utilizes encryption/decryption keys which are either generated locally (such as by encryption/decryption unit 517, or which are stored on an external key server and retrieved by encryption/decryption unit 517. It is possible to use “master keys” to encrypt encryption/decryption keys, thereby making it safe to store encryption/decryption keys on external storage instead of in limited internal memory. Accordingly, in an embodiment of the present invention, the mediator (such as via encryption/decryption unit 517) is able to use a master key to encrypt generated (or retrieved) encryption/decryption keys, and is able to use a master key to decrypt encryption/decryption keys when required in the encryption/decryption process of the stored data.

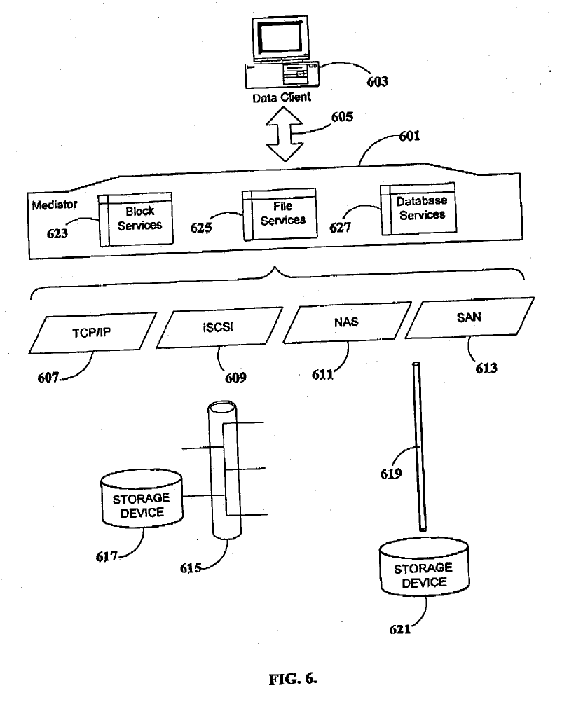

FIG. 6 illustrates the capacity of a mediator 601 to effort secure virtual data storage for a data client 603 over a network connection 605. The storage is considered “virtual” because the data from data client 603 can be stored on a variety of storage devices using a variety of protocols, technologies, and services, as managed by mediator 601. For example, mediator 601 is able to support technologies including, but not limited to a Gigabit Ethernet link 615, which connects to a data storage device 617 and a fiber channel 619, which connects to a data storage device 621 utilizing block device application protocols including, but not limited to, SCSI and iSCSI, and file system application protocols including, but not limited to, NFS. Moreover, mediator 601 is also able to provide block services 623, file services 625, and database services 627 (the capabilities for which are contained therein, as illustrated), while providing protocol translation between application protocols used with clients and application protocols used for storage devices and encrypting and decrypting the data that is stored on the storage devices. Additional application protocols include, but are not limited to, FCP (SCSI over FC), CIFS, and iSCSI. The mediator is able to provide block device services, file services, and database services, and is also able to provide encryption of the raw data (e.g., a block device's data, and a file's data).

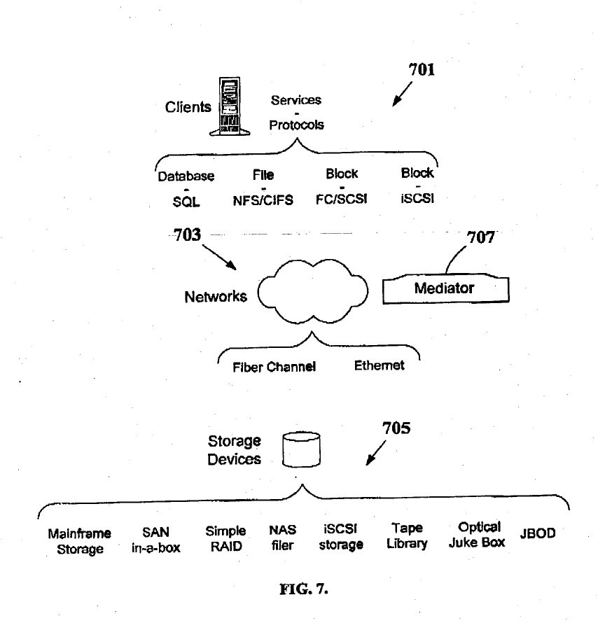

FIG. 7 illustrates some representative and non-limiting technologies and protocols known in the art which can be utilized by a configuration according to the present invention. Data client services and protocols 701 include, but are not limited to database services via SQL; file services via NFS/CIFS; block services via FC/SCSI; and block services via iSCSI. Networks 703 include, but are not limited to Fiber Channel and Ethernet. Storage devices 705 encompass various devices known in the art, including, but not limited to: mainframe storage; SAN-in-a-box; simple RAID; NAS filer; iSCSI storage; tape library; optical juke box; and JBOD (“Just a Bunch Of Disks”), which herein denotes any collection of one or more disk drives which does not necessarily include any special coordinating controller or data processing. A mediator 707 is associated with networks 703 to provide encryption and decryption services according to an embodiment of the present invention.

Encryption Scenarios

The following represent possible encryption scenarios in embodiments of the present invention. It is noted that these are all non-limiting examples provided for illustration, and that other scenarios are also possible within the framework of the invention.

A typical mediator data encryption scenario for writing data to storage may include:

1. extracting the actual data from the protocol used to communicate with the client (e g. block device protocols, file system protocols, database services protocols);

2. determining the storage properties of the data in order to provide for the matching encryption key (e.g. key of the logical unit storing the data, key of the file of which the data is part);

3. getting the key from the meta-data held by the mediator for that storage object;

4. decrypting that key using the mediator master key;

5. encrypting the data with the decrypted key; and

6. encapsulating the encrypted data within the protocol used to communicate with the storage device (e.g. block device protocols, file system protocols).

A variation on the above scenario involves creating the encryption key when first creating the storage object, and then encrypting that encryption key with the master key prior to storing the storage object meta-data for use in further encryption and decryption processes.

A typical mediator data decryption scenario for reading data from storage may include:

1. extracting the storage properties of the requested data from the client protocol;

2. retrieving the data from storage and extracting the data from the protocol used to communicate with the storage device (e.g. block device protocols, file system protocols);

3. getting the appropriate key according to the storage properties (e.g. key of the logical unit storing the data, key for the file of which the data is part);

4. decrypting that key using the mediator master key;

5. decrypting the data and encapsulating the data within the client protocol (e.g. block device protocols, file system protocols, database services protocols) as a response to the data client.

Additional variations on the above scenarios involve using a key server to generate, store and retrieve encryption keys according to a unique ID which the mediator stores for each storage object (e.g. logical units, files, directories). Retrieving keys must be protected, such as by using a secure communication protocol to maintain privacy and integrity of the keys, and to prevent unauthorized access to the keys.

While the invention has been described with respect to a limited number of embodiments, it will be appreciated that many variations, modifications and other applications of the invention may be made.

1. A mediator for the storage and protection of data over a network, the mediator comprising:
(a) an incoming network interface operative to connecting to a sending data client over an incoming network, and operative to receiving data from said sending data client;
(b) an encryption unit for encrypting said data received from said sending data client;
(c) a storage network interface operative to connecting to a data storage device over a storage network, for storing data in said data storage device after encryption by said encryption unit;
(d) a retrieval network interface operative to connecting to said data storage device over a retrieval network, for retrieving data from said data storage device;
(e) a decryption unit for decrypting said data retrieved from said data storage device; and
(f) an outgoing network interface operative to connecting to a receiving data client over an outgoing network, and operative to sending data to said receiving data client after decryption by said decryption unit.

2. The mediator of claim 1, wherein said encryption unit is operative to:
i) obtaining an encryption key from a source other than said sending data client; and
ii) encrypting said data received from said sending data client, using said encryption key.

3. The mediator of claim 2, wherein said encryption unit is further operative to;
iii) using a master key to encrypt said encryption key.

4. The mediator of claim 1, wherein said decryption unit is operative to:
i) obtaining a decryption key from a source other than said receiving data client; and
ii) decrypting said data retrieved from said data storage device, using said decryption key.

5. The mediator of claim 4, wherein said decryption unit is further operative to:
iii) using a master key to decrypt said decryption key.

6. The mediator of claim 1, wherein said sending data client is the same as said receiving data client.

7. The mediator of claim 1, wherein at least two of said incoming network interface, said storage network interface, said retrieval network interface, and said outgoing network interface are the same.

8. The mediator of claim 1, wherein at least two of said incoming network, said storage network, said retrieval network, and said outgoing network are the same.

9. The mediator of claim 1, wherein said encryption unit and said decryption unit are the same.

10. The mediator of claim 1, wherein at least one of said networks includes a plurality of different network interface technologies.

11. The mediator of claim 1, wherein at least one of said network interfaces includes a technology selected from a group including Gigabit Ethernet, TCP/IP, and Fiber Channel.

12. The mediator of claim 1, further comprising a protocol translator for bridging between networks utilizing different protocols.

13. The mediator of claim 1, wherein said at least one data client includes a client protocol, wherein said at least one at least one data storage device includes a device protocol, and wherein the mediator is operative to providing protocol translation between said client protocol and said device protocol.

14. The mediator of claim 1, operative to providing services selected from a group including: block services, file services, and database services.

15. The mediator of claim 14, operative to providing file services and encryption of file data only.

16. A configuration for secure data storage, the configuration comprising:
(a) a set of networks containing at least one network;
(b) a sending data client connected to an incoming network included in said set of networks;
(c) a receiving data client connected to an outgoing network included in said set of networks
(d) a storage network included in said set of networks and connecting to a data storage device;
(e) a retrieval network included in said set of networks and connecting to said data storage device; and
(f) a mediator connected to said incoming network, to said storage network, to said retrieval network, and to said outgoing network, wherein said mediator is operative to:
i) receiving, over said incoming network, data from said sending data client;
ii) obtaining an encryption key from a source other than said sending data client;
iii) encrypting said data received from said sending data client into encrypted data, using said encryption key;
iv) sending, over said storage network, said encrypted data to said data storage device for storage therein;
v) receiving, over said retrieval network, encrypted data retrieved from said data storage device;
vi) obtaining a decryption key from a source other than said receiving data client;
vii) decrypting said encrypt data retrieved from said data storage device into decrypted data, using said decryption key; and
viii) sending, over said outgoing network, said decrypted data to said receiving data client.

17. The configuration of claim 16, wherein said sending data client is the same as said receiving data client.

18. The configuration of claim 16, wherein at least two of said incoming network, said storage network, said retrieval network, and said outgoing network are the same.

19. The configuration of claim 16, wherein said encryption unit and said decryption unit are the same.

20. The configuration of claim 16, wherein said mediator is further operative to:
ix) a master key to encrypt said encryption key; and
x) using a master key to decrypt said decryption key.
